(19) United States
(12) Patent Application Publication
(10) Pub. No.: US 2003/0099065 A1
(43) Pub. Date: May 29, 2003

(54) Magnetic head having integrated circuit chip mounted on suspension and method of producing the same

(75) Inventor: Mitsuru Watanabe, Niigata-ken (JP)

Correspondence Address: Brinks Hofer Gilson & Lione, P. O. Box 10395, Chicago, IL, 60610, US

(73) Assignee: Alps Electric Co., Ltd.

(21) Appl. No.: 10/300,206

(22) Filed: Nov. 20, 2002

(30) Foreign Application Priority Data
Nov. 27, 2001 (JP) 2001-361000

(51) Int. Cl. G11B 5/48

(52) U.S. Cl. 360/244.1

(57) ABSTRACT

A magnetic head includes a suspension; a slider mounted on the suspension and having a magnetic head element; and an integrated circuit bare chip mounted on the suspension and having a control circuit for the magnetic head element. The entire surface of the IC bare chip is covered with a photo-curable and thermosetting resin material. The photo-curable and thermosetting resin material covering the IC bare chip is irradiated with light in order to harden the resin surface. Thereafter, the entire photo-curable and thermosetting resin material is heated and hardened.

### BACKGROUND OF THE INVENTION

1. Field of the Invention

The present invention relates to a magnetic head having an integrated circuit (IC) chip, including a control circuit for a magnetic head element, mounted on a suspension, and a method of producing the same. More particularly, the present invention relates to a magnetic head which makes it possible to effectively prevent the IC chip and the method of producing the same from production of dust.

2. Description of the Related Art

In recent years, higher capacity and higher density recording of magnetic disc devices have increased recording frequency. A COS (chip on suspension) type magnetic head, in which a drive circuit for a magnetic head element is used to form an IC bare chip and the IC bare chip is mounted on the suspension (which is a mechanism for supporting the magnetic head element), has been proposed as means for increasing recording frequency.

As shown in FIG. 7, a COS type magnetic head 50 comprises a suspension 53 comprising a resilient flexure 51 carrying a slider with the magnetic head element (not shown) and a resilient load beam 52 which supports the flexure 51.

Electrically conductive patterns 55a and 55b are formed on the flexure 51 through an insulating layer 54. The electrically conductive pattern 55a is led out from the magnetic head element and the electrical conductive pattern 55b is led out from an external circuit (not shown). Here, an end portion of the electrically conductive pattern 55a led out from the magnetic head element is formed as a connection pad 55c, and an end portion of the electrically conductive pattern 55b led out from the external circuit is formed as a connection pad 55d.

Bumps 57 of the IC chip 56 having a drive circuit for the magnetic head element are joined to the respective connection pads 55c and 55d on the flexure 51 by ultrasonic bonding.

In the magnetic head 50, after joining the bumps 57 and the respective connection pads 55c and 55d together by ultrasonic bonding, the entire IC chip 56 is covered with a thermosetting resin material 58 and the thermosetting resin material 58 is hardened by heating in order to protectively secure the IC chip 56.

However, in such related COS type magnetic head 50, as described above, since the IC bare chip 56 is covered with the thermosetting resin material 58, when the resin is left standing or, in particular, when the resin is heated and hardened, the thermosetting resin material 58 is vaporized and reduced in amount or the resin flows when it is hardening. Therefore, as shown in FIG. 7, a corner 56a of the IC chip 56 may become exposed.

In general, since the IC bare chip 56 is used without post-processing the surface of a portion cut out from a wafer, dust may be produced from such exposed corner 56a.

In addition, foreign matter (dust) produced from the IC bare chip 6 adheres to a surface of the magnetic head element opposing a medium or a surface of a recording medium, such as a magnetic disc, so that a crash occurs between a head slider and the recording medium or the recording medium surface is scratched, so that recording and/or reproducing operations cannot be precisely performed.

### SUMMARY OF THE INVENTION

The present invention has been proposed in view of the above-described related circumstances and has as its object the provision of a magnetic head which provides highly reliable recording and/or reproducing characteristics by making it possible to effectively prevent an integrated circuit bare chip from the production of dust; and a method of producing the same.

To this end, according to one aspect of the present invention, there is provided a magnetic head comprising a suspension, a slider mounted on the suspension and having a magnetic head element, and an integrated circuit bare chip mounted on the suspension and having a control circuit for the magnetic head element. In the magnetic head, the entire surface of the integrated circuit bare chip is covered with a photo-curable and thermosetting resin material.

By virtue of such a structure, according to the magnetic head of the present invention, irradiating photo-curable and thermosetting resin material covering the entire surface of the integrated circuit bare chip with light, such as ultraviolet light, pre-hardens the resin surface in order to temporarily fix the resin form. Thereafter, the entire resin can be hardened by heating. Therefore, vaporization of the resin component is effectively restricted, so that reduction in the amount of resin can be restricted. Consequently, it is possible to prevent exposure of a corner of the integrated circuit bare chip, and, thus, to prevent the integrated circuit bare chip from the production of dust, so that it is possible to prevent entry of foreign matter.

Although not exclusive, a gap between a surface of the integrated circuit bare chip that is mounted on the suspension and the suspension may be sealed with the photo-curable and thermosetting resin material. By this, heat which is generated when the integrated circuit bare chip operates is dissipated from the suspension through the photo-curable and thermosetting resin material.

Although not exclusive, the photo-curable and thermosetting resin material may primarily contain epoxy resin. This material can be easily hardened by light and heat.

Although not exclusive, the photo-curable and thermosetting resin material may contain at least 40 weight percent of a filler having high thermal conductivity with respect to the resin. By this, the thermal conductivity of the photo-curable and thermosetting resin material covering the integrated circuit bare chip is increased, so that heat which is generated when the integrated circuit bare chip operates can be effectively dissipated.

According to another aspect of the present invention, there is provided a method of producing a magnetic head comprising the steps of electrically connecting an integrated circuit bare chip having a control circuit for a magnetic head element to an electrically conductive pattern on a suspension with the magnetic head element; covering the entire surface of the integrated circuit bare chip with a photo-curable and thermosetting resin material; after covering the entire surface, irradiating the photo-curable and thermosetting resin material with light in order to harden the surface of the photo-curable and thermosetting resin material; and after the irradiation, heating the entire photo-curable and thermosetting resin material in order to harden it.

In such a method, the photo-curable and thermosetting resin material covering the entire surface of the integrated circuit bare chip is irradiated with light, such as ultraviolet light, in order to pre-harden the resin surface and temporarily fix the resin form. Thereafter, the entire resin is hardened by heating. Therefore, it is possible to restrict a reduction in the amount of resin by effectively restricting vaporization of the resin component. As a result, it is possible to provide a magnetic head which can prevent exposure of a corner of the integrated circuit bare chip, and, thus, prevent the integrated circuit bare chip from the production of dust, so that entry of foreign matter can be prevented from occurring.

### BRIEF DESCRIPTION OF THE DRAWINGS

FIG. 1 is a plan view of a magnetic head of an embodiment of the present invention;

FIG. 2 is a sectional view taken along line II-II of FIG. 1;

FIG. 3 is a sectional view for illustrating the step of joining an IC bare chip onto a suspension by ultrasonic bonding in the magnetic head of the embodiment of the present invention;

FIG. 4 is a sectional view for illustrating the step of dropping photo-curable and thermosetting resin material onto the entire surface of the IC bare chip in the magnetic head of the embodiment of the present invention;

FIG. 5 is a sectional view for illustrating the step of irradiating photo-curable and thermosetting resin material covering the entire surface of the IC bare chip with ultraviolet light in the magnetic head of the embodiment of the present invention;

FIG. 6 is a sectional view for illustrating the step of heating and hardening the photo-curable and thermosetting resin material covering the entire surface of the IC bare chip in the magnetic head of the embodiment of the present invention; and

FIG. 7 is a sectional view showing a state in which a corner of an IC bare chip of a related COS type magnetic head is exposed from thermosetting resin material.

### DESCRIPTION OF THE PREFERRED EMBODIMENT

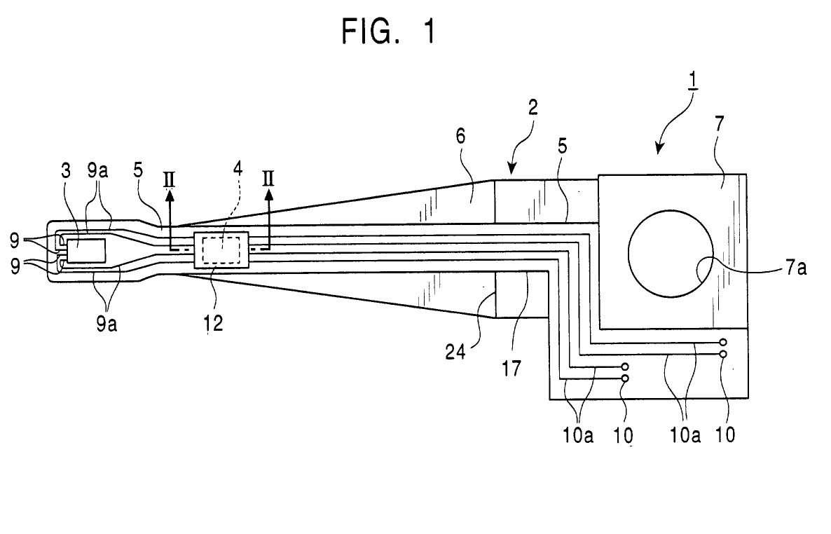

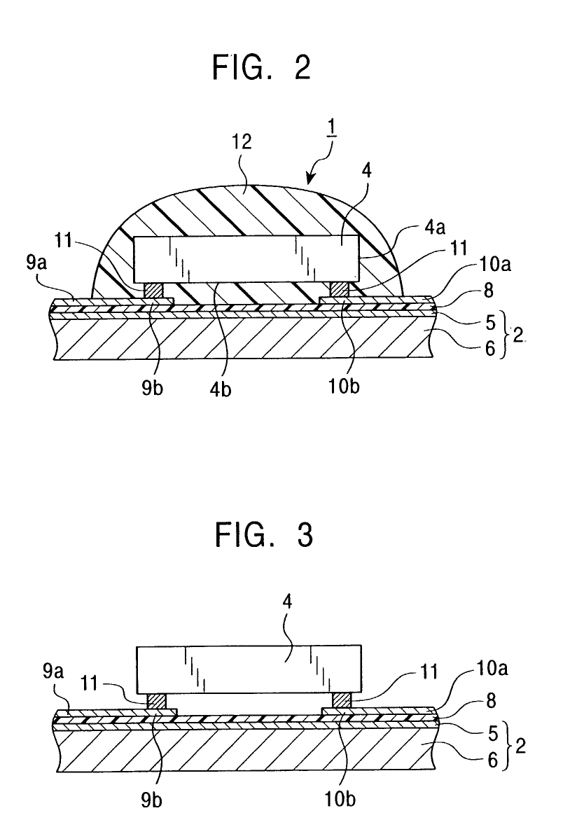

Hereunder, a description of an embodiment of the present invention will be given in detail with reference to the drawings. FIG. 1 is a plan view of a magnetic head of an embodiment of the present invention. FIG. 2 is a sectional view taken along line II-II of FIG. 1.

A magnetic head 1 of the embodiment is what is called a COS type magnetic head in which a read-out signal amplifying circuit, a drive circuit for a magnetic head element, etc., are used to form an IC bare chip, and the IC bare chip is mounted on a suspension (which is a mechanism for supporting the magnetic head element). Since the distance of wiring from the drive circuit to the magnetic head element is short, it is possible to reduce unwanted noise added to a head drive signal or readout signal, so that recording and/or reproducing characteristics in a high-frequency region are improved.

As shown in FIG. 1, in the magnetic head 1, a slider 3 with a thin-film magnetic head element (not shown) is mounted on an end of a long suspension 2, and an IC bare chip 4 for amplifying a read-out signal and driving the thin-film magnetic head element is mounted on the longitudinal-direction central portion of the suspension 2. Here, the slider 3 and the IC bare chip 4 are mounted on the surface of the suspension 2 opposing a medium.

In the present invention, only the slider 3 needs to be mounted on the surface of the suspension 2 opposing a medium, so that the IC bare chip 4 may be mounted on the surface of the suspension 2 opposite to the surface of the suspension 2 opposing a medium. However, when, as in the embodiment, the IC bare chip 4 is also provided on the surface of the suspension 2 opposing a medium, the IC bare chip which has generated heat by, for example, write current can be effectively cooled by air currents that are produced by rotation of the medium, such as a magnetic disc.

As shown in FIG. 1, the suspension 2 primarily comprises a long, resilient flexure 5 which carries the slider 3 at one end thereof and which supports the IC bare chip 4 at the longitudinal-direction central portion thereof; a load beam 6 which extends in the longitudinal direction of the flexure 5 and which supports the flexure 5 from the bottom surface of the flexure 5; and a base plate 7 which is provided at the bottom portion of the load beam 6.

The flexure 5 has a soft tongue at one end thereof with a dimple provided between it and the load beam 6 being the center, and has resiliency that allows it to flexibly support the slider 3 at the tongue. The flexure 5 is formed of, for example, a stainless steel plate, and has a shape with a width that is smaller than the width of the load beam 6.

On the other hand, the load beam 6 has a resiliency for holding down the slider 3 towards a surface of a medium, such as a magnetic disc, through the flexure 5. The load beam 6 is formed of, for example, a stainless steel plate, and has a shape with a width that becomes smaller towards an end thereof.

The flexure 5 and the load beam 6 are joined together by pin-point bonding using a plurality of welding points.

The base plate 7 is formed of, for example, stainless steel or iron and is welded and adhered to the bottom portion of the load beam 6. The base plate 7 is mounted on a movable arm (not shown) of the suspension 2 through a mounting portion 7a.

In the present invention, the flexure 5 and the load beam 6 do not have to be separately provided as in the above-described embodiment, so that the flexure and the load beam may be integrally formed. Accordingly, the suspension may have a two-piece structure comprising a base plate and an integrally formed flexure-load-beam.

As shown in FIG. 2, an insulating layer 8 is formed on top of the flexure 5. As shown in FIGS. 1 and 2, an electrically conductive pattern 9a, led out from a terminal electrode 9 of the thin-film magnetic head element provided on the slider 3, and an electrically conductive pattern 10a, led out from a terminal electrode 10 of an external circuit (not shown), are formed on the flexure 5 through the insulating layer 8.

Here, as shown in FIG. 2, an end of the electrically conductive pattern 9a, led out from the thin-film magnetic head element, is formed as a connection pad 9b for electrically connecting the thin-film magnetic head element to the IC bare chip 4. Similarly, an end of the electrically conductive pattern 10a, led out from the external circuit, is formed as a connection pad 10b for electrically connecting the external circuit to the IC bare chip 4. These connection pads 9b and 10b are formed of, for example, Cu—Au.

Bumps 11, formed of, for example, gold (Au), are provided on one surface of the IC bare chip 4. They are joined to the top portions of the respective Cu—Au connection pads 9b and 10b by ultrasonic bonding.

Here, the IC bare chip 4 is a semiconductor device in which a read-out signal amplifying circuit and a drive circuit, serving as head amplifiers, are used to form an integrated circuit on a semiconductor material, such as silicon (Si) or germanium (Ge). More specifically, the IC bare chip 4 is molded covering a semiconductor material, such as Si or Ge, without covering the semiconductor material with a container. In general, when a semiconductor material, such as Si or Ge, is covered with a container, the IC itself becomes heavy, so that the dynamic characteristics of the slider with the magnetic head element becomes poor, thereby making it impossible for the slider to properly follow the movement of a recording medium. Therefore, when, like the IC head chip 4 used in the embodiment, the IC head chip is molded covering a semiconductor material without covering the semiconductor material with a container, this problem can be overcome.

Although, in the embodiment, the IC bare chip is joined by ultrasonic bonding, the present invention is not limited thereto. Therefore, obviously, the IC bare chip 4 may be joined to the electrically conductive patterns 9a and 10a, formed on the flexure 5, by using solder, that is, by what is called flip chip bonding.

In particular, as shown in FIG. 2, the entire surface of the IC bare chip 4 used in the embodiment is completely covered with a photo-curable and thermosetting resin material 12 which can be hardened by both light and heat.

Specific examples of the photo-curable and thermosetting resin material 12 are resin materials primarily containing, for example, epoxy resin or acrylic resin. Of these materials, it is particularly desirable to use photo-curable and thermosetting resin material primarily containing epoxy resin because it has low outgas characteristics after hardening it by light and heat and it can be easily hardened by light and heat.

Outside oxygen makes it difficult to harden the photo-curable and thermosetting resin material primarily containing acrylic resin by light and heat, so that a hardening inhibiting effect tends to occur in this type of material. Therefore, when this type of material is used as a photo-curable and thermosetting resin material, in order to prevent entry of oxygen into the material, irradiation using light is carried out in an atmosphere of nitrogen from the step of coating the IC bare chip 4 in order to form a protective layer on the resin surface.

In this way, in the magnetic head 1 of the embodiment, the entire surface of the IC bare chip 4 is covered with the photo-curing/thermosetting resin material 12. Therefore, by irradiating the photo-curing/thermosetting resin material 12 with light, such as ultraviolet light, the resin surface is pre-hardened in order to temporarily fix the form of the resin. Thereafter, the entire resin can be hardened by heating. By this, according to the magnetic head 1 of the present invention, vaporization of the resin component is effectively restricted, so that reduction in the amount of resin can be restricted. Consequently, it is possible to prevent exposure of a corner 4a of the IC bare chip 4, and, thus, to prevent the IC bare chip from the production of dust, so that entry of foreign matter can be prevented from occurring.

It is desirable for the photo-curable and thermosetting resin material to contain at least 40 weight percent of a filler having high thermal conductivity with respect to the weight percent of resin. Examples of the filler are aluminum nitride, silicon nitride, and alumina.

By this, the thermal conductivity of the photo-curing/thermosetting resin material 12 covering the entire surface of the IC bare chip 4 is increased, so that heat generated during operation of the IC bare chip 4, particularly, during a writing operation, can be more easily dissipated. Therefore, it is possible to effectively prevent problems caused by heating during the operation of the IC bare chip 4, such as breakage of the IC bare chip 4 and destabilization of a signal due to changes in resistance of the electrically conductive patterns 9a and 10a.

In the embodiment, as shown in FIG. 2, a bottom surface 4b, which is a surface of the IC bare chip 4 that is bonded, a gap between the bottom surface 4b and the insulating layer 8, and the top and side surfaces of the IC bare chip 4 are all sealed or covered by the same photo-curable and thermosetting resin material 12. More specifically, ordinarily, the same photo-curable and thermosetting resin material 12 used in the embodiment refers to resin of an underfill layer, disposed between the surface of the IC bare chip 4 which is bonded and the insulating layer 8, and mold resin for protecting the IC bare chip covering the top and side surfaces of the IC bare chip 4.

By virtue of such a structure, in the embodiment, it becomes unnecessary to consider, for examples, interference between resins or differences in degree of hardening, so that the manufacturing process becomes easier to perform.

The heat which is generated during the operation of the IC bare chip 4 is dissipated to the flexure or the load beam through the resin of the underfill layer. Therefore, as in the embodiment, it is desirable for the IC bare chip 4 and the flexure 5 be completely connected with resin.

The COS type magnetic head 1 of the embodiment having the above-described structure has its IC bare chip 4 mounted in the following way. FIGS. 3 to 6 are sectional views for illustrating the steps of mounting the IC bare chip 4 in the magnetic head 1 of the embodiment.

First, as shown in FIG. 3, the IC bare chip 4 is positioned and disposed on the connection pads 9b and 10b so that the bumps 11, formed of gold (Au) and provided on the bottom surface of the IC bare chip 4, oppose the respective Cu—Au connection pads 9b and 10b.

The bumps 11 of the IC bare chip 4 and the connection pads 9b and 10b are welded and joined by ultrasonic bonding, so that the IC bare chip 4 is mounted onto the suspension 2. In this way, the IC bare chip 4 is electrically connected to the electrically conductive patterns 9a and 10a on the suspension 2.

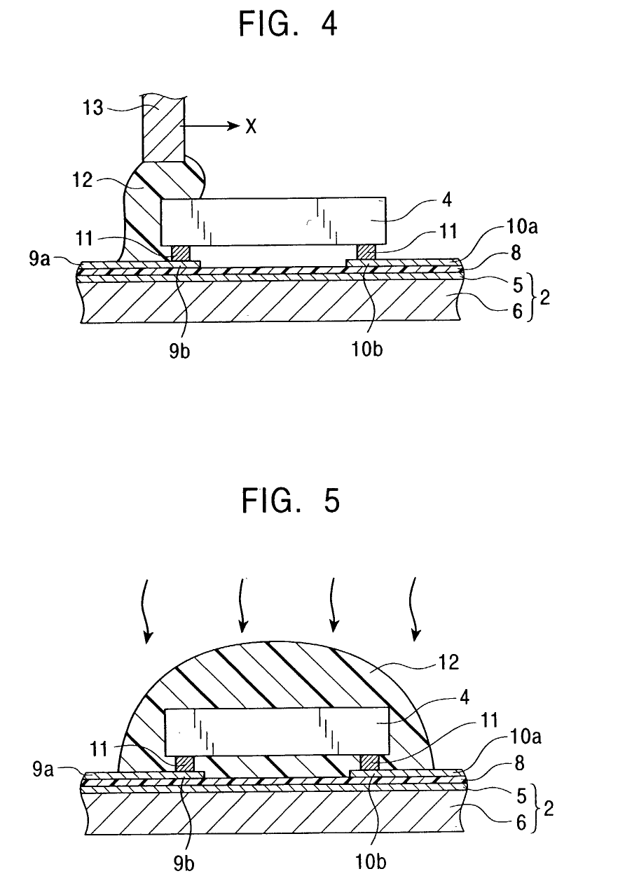

Next, as shown in FIG. 4, dropping of the photo-curable and thermosetting resin material 12 towards the top surface of the IC bare chip 4 from a nozzle 13 disposed above the IC bare chip 4 is started. While moving the nozzle 13 in the direction of arrow X in FIG. 4, the dropping of the photo-curable and thermosetting resin material 12 is continued.

With the entire surface of the IC bare chip 4 being covered with the photo-curable and thermosetting resin material 12, the dropping of the photo-curable and thermosetting resin material 12 from the nozzle 13 is stopped. Here, when, for example, the size of the IC bare chip 4 is 1.5×1.5×0.2 mm, the total amount of photo-curable and thermosetting resin material 12 required to cover the entire surface of the IC bare chip 4 is approximately 2 mg.

Next, as shown in FIG. 5, the photo-curable and thermosetting resin material 12 covering the entire surface of the IC bare chip 4 is irradiated with ultraviolet light (wavelength 365 nm) at 5000 mJ/cm² (integral light quantity). At this time, the surface of the photo-curable and thermosetting resin material 12 covering the IC bare chip 4 is hardened, so that the IC bare chip 4 is temporarily secured.

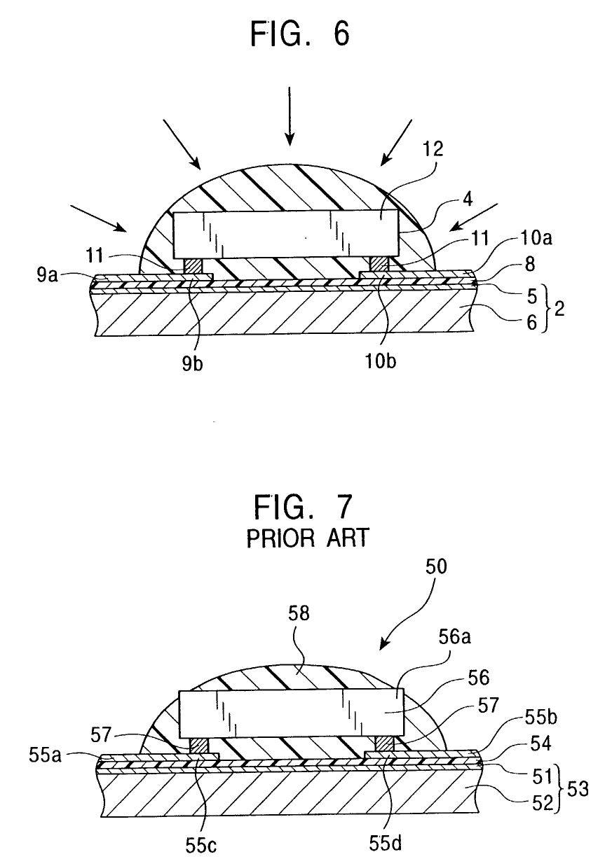

Lastly, as shown in FIG. 6, the entire photo-curable and thermosetting resin material 12 covering the IC bare chip 4 whose resin surface has been hardened is heated to a predetermined temperature and hardened.

In this way, in the method of producing the magnetic head 1 of the embodiment, the resin surface is hardened by irradiating it with light, such as ultraviolet light, and the IC bare chip 4 is temporarily secured. With the form of the resin whose surface has been hardened being maintained, the entire photo-curable and thermosetting resin material 12 (including the inside thereof) covering the entire surface of the IC bare chip 4 is hardened by heat. By this, according to the embodiment, vaporization of the resin component is effectively restricted, and the flow of resin can be restricted, so that reduction in the amount of resin can be restricted. Consequently, it is possible to prevent exposure of the corner 4a of the IC bare chip 4, and, thus, to prevent the IC bare chip 4 from the production of dust, so that entry of foreign matter during the manufacturing process can be prevented from occurring.

As mentioned in detail above, according to the present invention, irradiating photo-curable and thermosetting resin material covering the entire surface of the IC bare chip with light, such as ultraviolet light, pre-hardens the resin surface. Thereafter, the entire resin can be hardened by heating. Therefore, vaporization of the resin component is effectively restricted, so that reduction in the amount of resin can be restricted. Consequently, it is possible to prevent exposure of a corner of the IC bare chip. By this, according to the present invention, it is possible to prevent the IC bare chip from the production of dust, so that entry of foreign matter can be prevented. As a result, it is possible to provide a magnetic head which has highly reliable recording and/or reproducing characteristics and which has high productivity, and a method of producing the same.

[image]

[image]

What is claimed is:

1. A magnetic head comprising:
a suspension;
a slider with a magnetic head element, the slider being mounted on the suspension; and
an integrated circuit bare chip with a control circuit for the magnetic head element, the integrated circuit bare chip being mounted on the suspension,
wherein the entire surface of the integrated circuit bare chip is covered with a photo-curable and thermosetting resin material.

2. A magnetic head according to claim 1, wherein a gap between a surface of the integrated circuit bare chip which is mounted on the suspension and the suspension is sealed with the photo-curable and thermosetting resin material.

3. A magnetic head according to claim 1, wherein the photo-curable and thermosetting resin material primarily contains epoxy resin.

4. A magnetic head according to claim 1, wherein the photo-curable and thermosetting resin material contains at least 40 weight percent of a filler having high thermal conductivity with respect to the resin.

5. A method of producing a magnetic head comprising the steps of:
electrically connecting an integrated circuit bare chip having a control circuit for a magnetic head element to an electrically conductive pattern on a suspension with the magnetic head element;
covering the entire surface of the integrated circuit bare chip with a photo-curable and thermosetting resin material;
irradiating the photo-curable and thermosetting resin material with light in order to harden the surface of the photo-curable and thermosetting resin material; and
after the irradiation, heating the entire photo-curable and thermosetting resin material in order to harden it.
